(19) United States
(12) Patent Application Publication
(10) Pub. No.: US 2017/0371234 A1
(43) Pub. Date: Dec. 28, 2017

(54) WAVELENGTH CONVERSION DEVICE, LIGHTING DEVICE, AND PROJECTOR

(71) Applicant: SEIKO EPSON CORPORATION, Tokyo (JP)

(72) Inventor: Tetsuo SHIMIZU, Matsumoto-shi (JP)

(73) Assignee: SEIKO EPSON CORPORATION, Tokyo (JP)

(21) Appl. No.: 15/618,263

(22) Filed: Jun. 9, 2017

(30) Foreign Application Priority Data
Jun. 28, 2016 (JP) 2016-127697
Mar. 22, 2017 (JP) 2017-055478

(51) Int. Cl. G03B 21/20; F21V 9/16; G03B 33/12; G03B 21/00; F21Y 2115/30

(52) U.S. Cl. CPC G03B 21/204; F21V 9/16; G03B 33/12; F21Y 2115/30; G03B 21/006

(57) ABSTRACT

A wavelength conversion device includes a wavelength conversion element configured to convert at least a part of incident excitation light into converted light having a wavelength different from a wavelength of the excitation light and emit the converted light and a substrate connected to the wavelength conversion element in a crossing direction crossing an incident direction of the excitation light on the wavelength conversion element and configured to radiate heat transferred from the wavelength conversion element. A dimension of the substrate along the incident direction is larger than a dimension of the wavelength conversion element along the incident direction.

### CROSS REFERENCE TO RELATED APPLICATION

The entire disclosure of Japanese Patent Application No. 2016-127697, filed Jun. 28, 2016 and No. 2017-055478, filed Mar. 22, 2016 is expressly incorporated by reference herein.

### BACKGROUND

### 1. Technical Field

The present invention relates to a wavelength conversion device, a lighting device, and a projector.

### 2. Related Art

There has been known a light source device that performs wavelength conversion of excitation light emitted from a solid-state light source and emits fluorescent light (see, for example, JP-A-2013-156657 (Patent Literature 1)).

The light source device described in Patent Literature 1 includes three fluorescent-light generation devices that generate lights in wavelength bands of red, green, and blue. The fluorescent-light generation device includes an excitation light source, a condensing lens, a phosphor, a mirror surface box that supports the phosphor, a dichroic filter that transmits emitted light and reflects excitation light, and a condensing optical system. In the fluorescent-light generation device, excitation light emitted from the excitation light source is made incident on the phosphor via the condensing lens and an incident opening of the mirror surface box that supports the phosphor. Light subjected to wavelength conversion by the phosphor is emitted to the outside via the dichroic filter and the condensing optical system.

Incidentally, heat is generated in the phosphor that performs the wavelength conversion of the incident excitation light. When the temperature of the phosphor rises, adverse effects such as deterioration in wavelength conversion efficiency occur.

On the other hand, in the fluorescent-light generation device of the light source device described in Patent Literature 1, a component for cooling the phosphor is not provided. Therefore, the temperature of the phosphor (a wavelength conversion element) easily rises. Emission efficiency (wavelength conversion efficiency) of light emitted from the wavelength conversion element is easily deteriorated.

As measures against this problem, it is conceivable to extend a substrate, which supports the wavelength conversion element in a direction orthogonal to an incident direction of the excitation light, in the orthogonal direction and expands a heat radiation area of heat conducted from the wavelength conversion element. However, when the substrate is expanded in this way, the heat conducted to the substrate is easily filled in a substantially center portion of the substrate. The heat conducted from the wavelength conversion element cannot be efficiently radiated. Therefore, the wavelength conversion element cannot be effectively cooled.

### SUMMARY

An advantage of some aspects of the invention is to provide a wavelength conversion device, a lighting device, and a projector that can suppress deterioration in wavelength conversion efficiency.

A wavelength conversion device according to a first aspect of the invention includes: a wavelength conversion element configured to convert at least a part of incident excitation light into converted light having a wavelength different from a wavelength of the excitation light and emit the converted light; and a substrate connected to the wavelength conversion element in a crossing direction crossing an incident direction of the excitation light on the wavelength conversion element and configured to radiate heat transferred from the wavelength conversion element. A dimension of the substrate along the incident direction is larger than a dimension of the wavelength conversion element along the incident direction.

According to the first aspect, it is possible to set an area of a cross section orthogonal to the crossing direction in the substrate (hereinafter referred to as substrate side sectional area) larger than an area of a cross section orthogonal to the crossing direction in the wavelength conversion element. Therefore, it is possible to increase the substrate side sectional area compared with when the dimension along the incident direction in the substrate is equal to or smaller than the dimension along the same direction in the wavelength conversion element. It is possible to expand an area of a conduction path on which heat transferred from the wavelength conversion element is conducted in a direction away from the wavelength conversion element on the inside of the substrate. Consequently, it is possible to reduce thermal resistance of the substrate. It is possible to efficiently conduct the heat, which is transferred from the wavelength conversion element to the substrate, to a part away from the wavelength conversion element in the substrate without allowing the heat to be filled in the inside of the substrate. Therefore, it is possible to effectively cool the wavelength conversion element. It is possible to suppress deterioration in wavelength conversion efficiency in the wavelength conversion element.

In the first aspect, it is preferable that the substrate includes an opening section piercing through the substrate along the incident direction, the wavelength conversion element being fit in the opening section.

With such a configuration, in a state in which the wavelength conversion element is surrounded by an inner end face of the opening section, the wavelength conversion element is connected to the inner end face. Consequently, for example, compared with when only a part of a side surface of the wavelength conversion element is connected to the substrate, it is possible to expand a contact area of the wavelength conversion element and the substrate. Therefore, it is possible to efficiently transfer the heat generated in the wavelength conversion element to the substrate.

In the first aspect, it is preferable that the substrate includes a projecting section located on at least either one of an incident side of the excitation light and an opposite side of the incident side of the excitation light with respect to the wavelength conversion element, and the projecting section includes an inclined surface further away from the wavelength conversion element toward a disposition side of the projecting section with respect to the wavelength conversion element.

With such a configuration, it is possible to surely set the dimension of the substrate larger than the dimension of the wavelength conversion element. Therefore, it is possible to surely set the substrate side sectional area larger than the element side sectional area. Consequently, it is possible to efficiently conduct the heat, which is transferred from the wavelength conversion element, in a direction away from the wavelength conversion element in the substrate. Therefore, it is possible to more effectively cool the wavelength conversion element.

Compared with a configuration without the inclined surface (e.g., a configuration in which the inner end face of the opening section extends along the incident direction), it is possible to suppress at least either one of light made incident on the wavelength conversion element and light emitted from the wavelength conversion element from being blocked by the substrate.

In the first aspect, it is preferable that the projecting section includes an incident-side projecting section located on an incident side of the excitation light with respect to the wavelength conversion element, and an incident-side inclined surface, which is the inclined surface in the incident-side projecting section, reflects the incident light.

With such a configuration, as explained above, compared with when the incident-side inclined surface is absent, it is possible to suppress the excitation light made incident on the wavelength conversion element from being blocked by the substrate.

Even when the excitation light is made incident on the incident-side inclined surface, since the excitation light is reflected by the incident-side inclined surface, it is possible to easily make the excitation light incident on the wavelength conversion element. Therefore, it is possible to effectively use the excitation light made incident on the wavelength conversion device.

In the first aspect, it is preferable that the wavelength conversion element includes: an incident surface on which the excitation light is made incident; and an emission surface located on an opposite side of the incident surface, the converted light being emitted from the emission surface, the projecting section includes an emission-side projecting section located on an opposite side of the incident side of the excitation light with respect to the wavelength conversion element, the opposite side being an emission side of the converted light from the emission surface, and an emission-side inclined surface, which is the inclined surface in the emission-side projecting section, reflects the incident light.

With such a configuration, when the wavelength conversion element is a wavelength conversion element of a transmission type that emits the converted light along the incident direction of the excitation light, compared with when the emission-side inclined surface is absent, it is possible to suppress the light emitted from the wavelength conversion element from being blocked by the substrate.

Even when light emitted from the emission surface is made incident on the emission-side inclined surface, since the light is reflected by the emission-side inclined surface, it is possible to easily emit the converted light to the outside of the wavelength conversion device. Therefore, it is possible to suppress a decrease in a light amount of light emitted from the wavelength conversion device.

In the first aspect, it is preferable that at least a part of the emission-side inclined surface is curved in a direction further away from the wavelength conversion element toward the emission side of the converted light.

The converted light emitted from the wavelength conversion element is emitted to diffuse from the emission surface of the wavelength conversion element.

On the other hand, with the configuration explained above, it is possible to easily separate the emission-side projecting section from the wavelength conversion element. Therefore, it is possible to suppress the light emitted from the wavelength conversion element from being incident on the emission-side projecting section. It is possible to suppress the emission-side projecting section from blocking the light. Therefore, it is possible to suppress a decrease in a light amount of the light emitted from the wavelength conversion device.

Since the emission-side inclined surface is curved, compared with when the emission-side inclined surface is formed in a flat shape, it is possible to easily expand an area of the emission-side inclined surface, that is, a heat radiation area of the heat transferred to the substrate. Therefore, it is possible to improve cooling efficiency of the wavelength conversion element.

In the first aspect, it is preferable that the wavelength conversion element is formed by an inorganic material.

Note that ceramic and the like can be illustrated as the inorganic material.

With such a configuration, compare with when the wavelength conversion element is formed by an organic material, it is possible to suppress deterioration of the wavelength conversion element. Therefore, it is possible to improve the reliability of the wavelength conversion device.

A lighting device according to a second aspect of the invention includes: the wavelength conversion device described above; and a light source configured to emit the excitation light.

According to the second aspect, it is possible to achieve effects same as the effects of the wavelength conversion device according to the first aspect. Consequently, it is possible to improve the reliability and the stability of the lighting device.

In the second aspect, it is preferable that the excitation light is blue light, and the converted light includes red light and green light.

With such a configuration, by adjusting a type and concentration of the phosphor included in the wavelength conversion element, it is possible to configure the lighting device such that white light including the excitation light and the converted light is emitted from the wavelength conversion element. Consequently, it is unnecessary to separately provide a component that divides the excitation light, which is the blue light, emitted from the light source and combines the excitation light with the converted light emitted from the wavelength conversion element and a light source that emits the blue light combined with the converted light. Therefore, it is possible to simplify the configuration of the lighting device.

A projector according to a third aspect of the invention includes: the lighting device described above; a light modulation device configured to modulate light emitted from the lighting device; and a projection optical device configured to project the light modulated by the light modulation device.

According to the third aspect, it is possible to achieve effects same as the effects of the wavelength conversion device according to the first aspect and the lighting device according to the second aspect. Consequently, it is possible to improve the reliability and the stability of the projector.

### BRIEF DESCRIPTION OF THE DRAWINGS

The invention will be described with reference to the accompanying drawings, wherein like numbers reference like elements.

FIG. 1 is a schematic diagram showing the configuration of a projector according to an embodiment of the invention.

FIG. 2 is a schematic diagram showing the configuration of a lighting device of the projector according to the embodiment.

FIG. 3 is a front view of a wavelength conversion device according to the embodiment viewed from an incident side of excitation light.

FIG. 4 is a sectional view showing the wavelength conversion device according to the embodiment.

FIG. 5 is a sectional view showing a wavelength conversion device according to a first modification of the embodiment.

FIG. 6 is a sectional view showing a wavelength conversion device according to a second modification of the embodiment.

FIG. 7 is a sectional view showing a wavelength conversion device according to a third modification of the embodiment.

FIG. 8 is a sectional view showing a wavelength conversion device according to a fourth modification of the embodiment.

### DESCRIPTION OF EXEMPLARY EMBODIMENTS

An embodiment of the invention is explained below with reference to the drawings.

### Schematic Configuration of a Projector

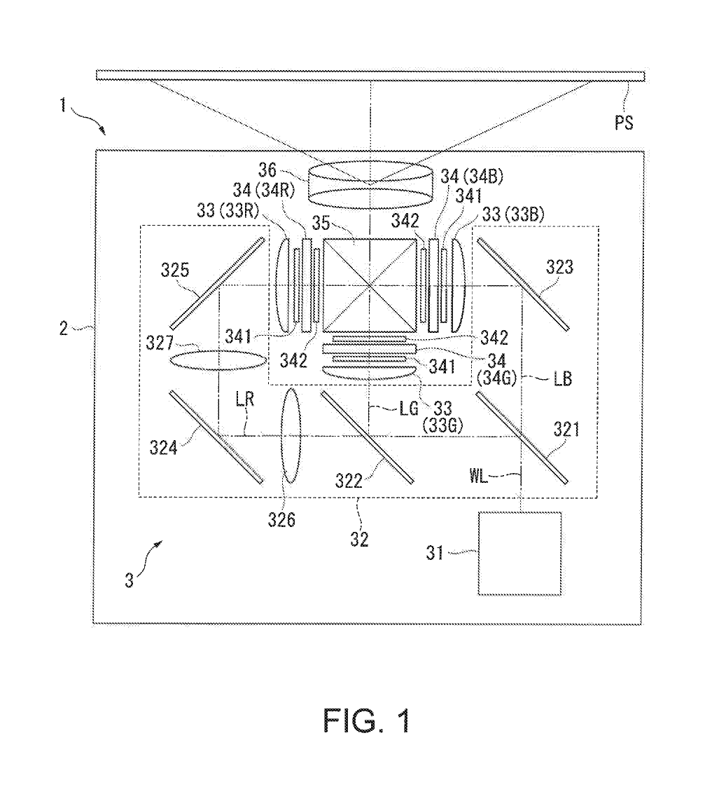

FIG. 1 is a schematic diagram showing a schematic configuration of a projector 1 according to this embodiment.

The projector 1 is a display apparatus that modulates a light beam emitted from a light source provided on the inside, forms an image corresponding to image information, and enlarges and projects the image on a projection surface PS such as a screen.

The projector 1 includes, as shown in FIG. 1, an exterior housing 2 and an image projection device 3 housed in the exterior housing 2. Besides, although not shown in the figure, the projector 1 includes a control device that controls the projector 1, a cooling device that cools a cooling target, and a power supply device that supplies electronic power to electronic components configuring the projector 1.

As explained in detail below, the projector 1 includes a wavelength conversion element 43 that converts at least a part of incident excitation light into fluorescent light (converted light) and emits the fluorescent light and a substrate 41 that supports the wavelength conversion element 43 and radiates heat conducted from the wavelength conversion element 43. As one of characteristics of the projector 1, a dimension along an incident direction of the excitation light in the substrate 41 is larger than a dimension along the incident direction in the wavelength conversion element 43.

The configuration of the projector 1 is explained below.

### Configuration of the Image Projection Device

The image projection device 3 includes a lighting device 31, a color separation device 32, a collimating lens 33, a plurality of light modulation devices 34, a color combination device 35, and a projection optical device 36 respectively disposed on an illumination light axis Ax, which is an optical axis in design.

The lighting device 31 emits illumination light WL. Note that the configuration of the lighting device 31 is explained in detail below.

The color separation device 32 separates the illumination light WL made incident from the lighting device 31 into three color lights, that is, red light LR, green light LG, and blue light LB. The color separation device 32 includes dichroic mirrors 321 and 322, total reflection mirrors 323, 324, and 325, and relay lenses 326 and 327.

The dichroic mirror 321 separates the blue light LB and light including the other color lights (the green light LG and the red light LR) from the illumination light WL emitted from the lighting device 31. Specifically, the dichroic mirror 321 transmits the blue light LB and reflects the light including the green light LG and the red light LR.

The dichroic mirror 322 separates the green light LG and the red light LR from the lights separated by the dichroic mirror 321. Specifically, the dichroic mirror 322 reflects the green light LG and transmits the red light LR.

The total reflection mirror 323 is disposed on an optical path of the blue light LB. The total reflection mirror 323 reflects the blue light LB transmitted by the dichroic mirror 321 toward the light modulation device 34 (34B).

The total reflection mirrors 324 and 325 are disposed on an optical path of the red light LR. The total reflection mirrors 324 and 325 guide the red light LR transmitted through the dichroic mirror 322 to the light modulation device 34 (34R). Note that the green light LG is reflected toward the light modulation device 34 (34G) by the dichroic mirror 322.

The relay lenses 326 and 327 are disposed downstream of the dichroic mirror 322 on the optical path of the red light LR. The relay lenses 326 and 327 have a function of compensating for an optical loss of the red light LR caused when the optical path length of the red light LR is longer than the optical path lengths of the blue light LB and the green light LG.

The collimating lens 33 collimates light made incident on the light modulation device 34. Note that the collimating lenses for the color lights of red, green, and blue are respectively represented as 33R, 33G, and 33B. The light modulation devices for the color lights of red, green, and blue are respectively represented as 34R, 34G, and 34B.

The plurality of light modulation devices 34 (34R, 34G, and 34B) respectively modulate the incident color lights LR, LG, and LB according to image information and form image lights corresponding to the color lights LR, LG, and LB. The light modulation devices 34 are configured by liquid crystal panels that modulate incident lights. Note that incident-side polarizing plates 341 and emission-side polarizing plates 342 are disposed on light incident sides and light emission sides of the light modulation devices 34R, 34G, and 34B.

The color combination device 35 combines the image lights made incident from the light modulation devices 34R, 34G, and 34B. In this embodiment, the color combination device 35 is configured by a cross dichroic prism. However, the color combination device 35 may be configured by a plurality of dichroic mirrors.

The projection optical device 36 projects the image light combined by the color combination device 35 on the projection surface PS such as the screen.

An enlarged image is projected on the projection surface PS by the configuration explained above.

### Configuration of the Lighting Device

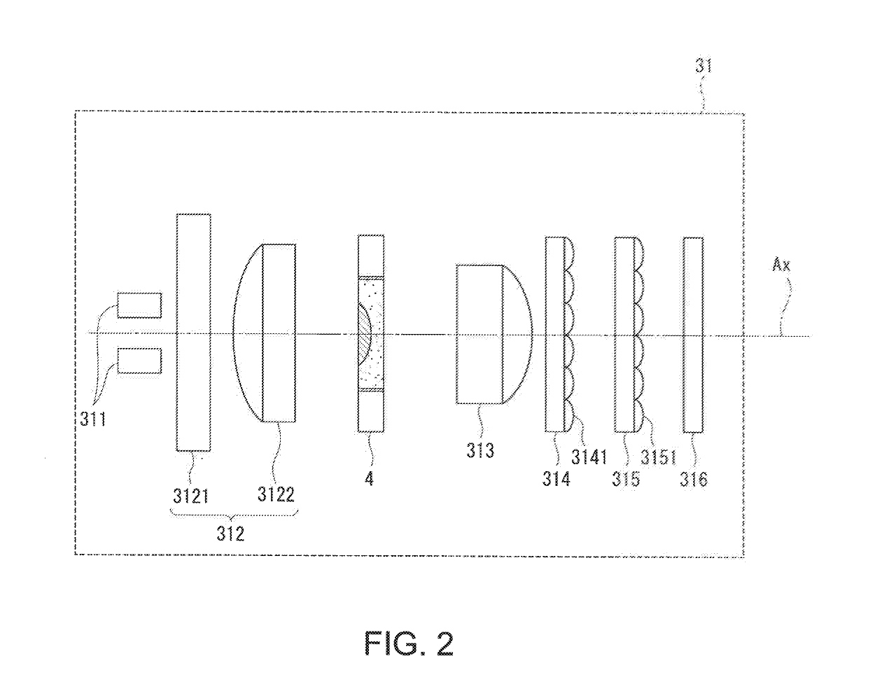

FIG. 2 is a schematic diagram showing the configuration of the lighting device 31 in the projector 1 in this embodiment.

The lighting device 31 emits uniform illumination light WL, a polarization direction of which is aligned, to the color separation device 32. The lighting device 31 includes a solid-state light source 311, a condensing optical device 312, the wavelength conversion device 4, a collimate lens 313, a first lens array 314, a second lens array 315, and a polarization conversion element 316.

The solid-state light source 311 is a laser light source that emits excitation light (the peak of light emission intensity: approximately 455 nm), which is blue laser light. The solid-state light source 311 is equivalent to the light source according to the invention.

Note that the solid-state light source 311 may include one laser light source (LD: Laser Diode) or may include a plurality of laser light sources. A solid-state light source that emits blue light, the peak of light emission intensity of which is a wavelength other than 455 nm, as excitation light may be adopted.

The condensing optical device 312 includes a first lens 3121 and a second lens 3122. The condensing optical device 312 condenses, with the first lens 3121 and the second lens 3122, excitation light made incident from the solid-state light source 311 and makes the excitation light incident on the wavelength conversion device 4. As the first lens 3121 and the second lens 3122, a combination of a convex lens and a concave lens can be illustrated.

The wavelength conversion device 4 converts a part of incident excitation light into converted light having a wavelength different from the wavelength of the excitation light and emits light including the converted light to the opposite side of an incident side of the excitation light. That is, the wavelength conversion device 4 is a wavelength conversion device of a transmission type that emits, along an incident direction of the excitation light, light including the part of the excitation light and fluorescent light. Note that a detailed configuration of the wavelength conversion device 4 is explained below.

The collimate lens 313 substantially collimates light made incident from the solid-state light source 311.

The first lens array 314 includes a plurality of first small lenses 3141 that divide the light made incident from the collimate lens 313 into a plurality of partial light beams.

The second lens array 315 includes a plurality of second small lenses 3151 corresponding to the plurality of first small lenses 3141. The second lens array 315 forms images of the first small lenses 3141 made incident from the first lens array 314 in the vicinities of image formation regions of the light modulation devices 34R, 34G, and 34B to thereby superimpose the plurality of partial light beams on the image formation regions. Note that the second small lenses 3151 are also arrayed in a matrix shape in a plane orthogonal to the illumination optical axis Ax.

The polarization conversion element 316 has a function of aligning polarization directions of the partial light beams divided by the first lens array 314.

### Configuration of the Wavelength Conversion Device

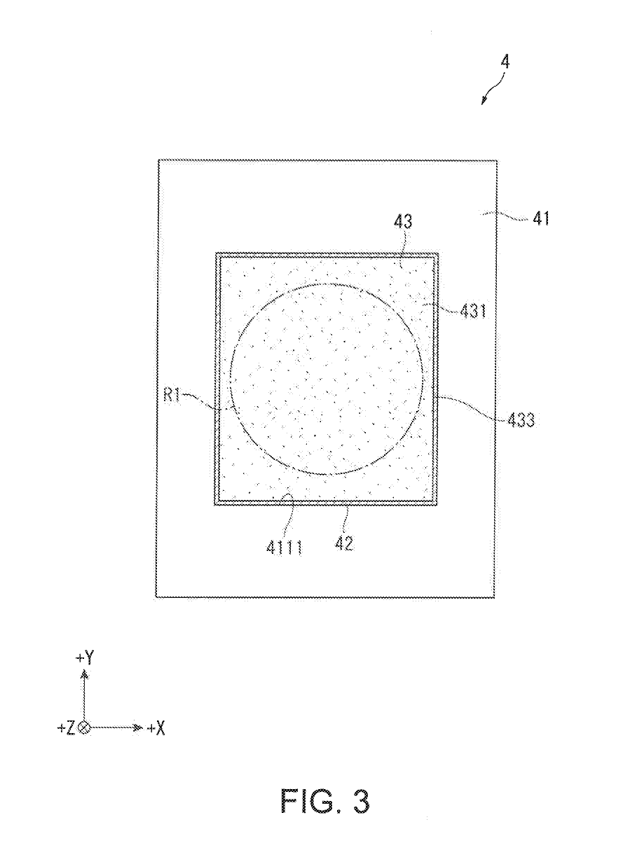

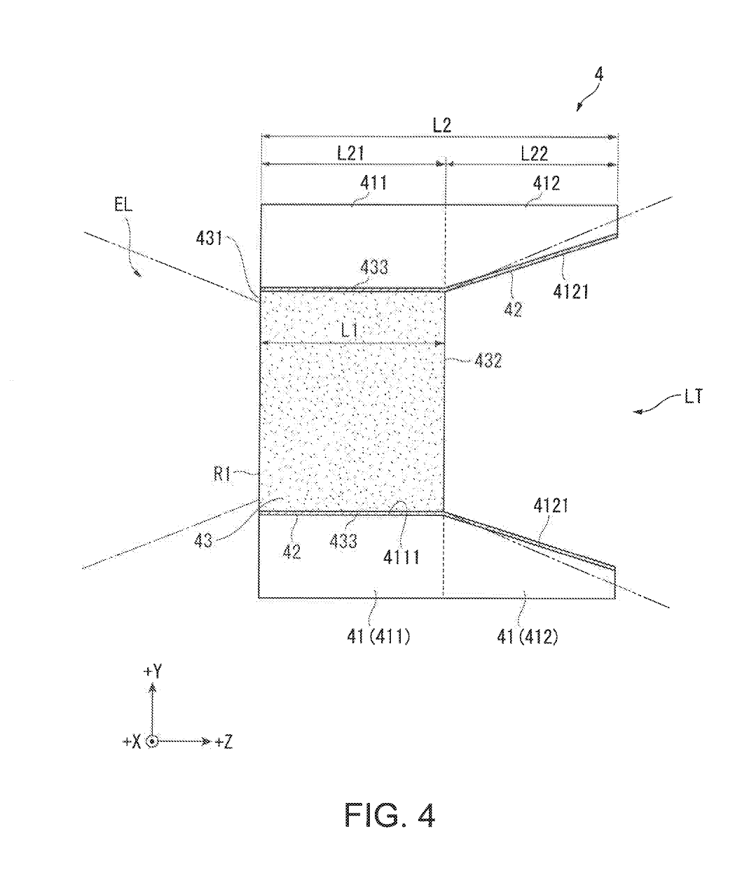

FIG. 3 is a plan view of the wavelength conversion device 4 viewed from a light incident side. FIG. 4 is a sectional view of the wavelength conversion device 4.

The wavelength conversion device 4 includes, as shown in FIGS. 3 and 4, the substrate 41 and the wavelength conversion element 43.

Note that, in the following explanation, a traveling direction of excitation light made incident from the solid-state light source 311 is represented as a +Z direction. Two directions orthogonal to the +Z direction and orthogonal to each other are respectively represented as a +X direction and a +Y direction. Although not shown in the figures, the opposite direction of the +Z direction is represented as a −Z direction. Among these directions, the +Z direction is a direction along an incident direction of the excitation light on the wavelength conversion element 43. The +X direction and the +Y direction are directions included in a crossing direction crossing the incident direction.

### Configuration of the Wavelength Conversion Element

The wavelength conversion element 43 is explained first.

The wavelength conversion element 43 converts apart of incident excitation light EL into fluorescent light (converted light) having a wavelength different from the wavelength of the excitation light EL and emits white emitted light LT (see FIG. 4) including the fluorescent light and another part of the excitation light EL to the opposite side of an incident side of the excitation light EL. Specifically, the wavelength conversion element 43 converts a part of the excitation light EL made incident on the wavelength conversion element 43 into fluorescent light (a peak wavelength: approximately 550 nm) including red light and green light. The wavelength conversion element 43 includes a mixture of a yellow phosphor and either one of a green phosphor and a red phosphor. The concentrations of the phosphors are set on the basis of a wavelength distribution of the illumination light WL emitted from the lighting device 31. The phosphors are formed by, for example, a ceramic phosphor formed by ceramic or a phosphor obtained by mixing phosphor powder and a glass binder. That is, the wavelength conversion element 43 is formed by an inorganic material.

### An Irradiation Region of Excitation Light Made Incident on the Wavelength Conversion Element and an Emission Range of Emitted Light

The excitation light EL made incident on the wavelength conversion element 43 is made incident in an irradiation region R1 having a substantially circular shape indicated by an alternate long and short dash line in FIGS. 3 and 4 on an incident surface 431 of the wavelength conversion element 43.

On the other hand, as shown in FIG. 4, the emitted light LT including excitation light not converted by the wavelength conversion element 43 and fluorescent light converted by the wavelength conversion element 43 is emitted from an emission surface 432, which is a surface on the +Z-direction side in the wavelength conversion element 43. The emitted light LT is diffused and emitted from the emission surface 432 as indicated by an alternate long and two short dashes line in FIG. 4.

### Configuration of the Substrate

The substrate 41 functions as a supporting member that supports the wavelength conversion element 43 and functions as a heat radiation member that radiates heat transferred from the wavelength conversion element 43. As shown in FIG. 3, the substrate 41 is formed in a substantially rectangular shape when viewed from the incident side (the −Z-direction side) of the excitation light EL. The substrate 41 includes, as shown in FIG. 4, a main body section 411 connected to the wavelength conversion element 43 and a projecting section 412 formed integrally with the main body section 411.

Note that, in this embodiment, the substrate 41 is configured by aluminum having relatively high thermal conductivity. However, the material of the substrate 41 is not limited to this. For example, the substrate 41 may be configured by another material as long as the material is a material having high thermal conductivity and high heat radiation such as other kind of metal such as magnesium or ceramic.

As shown in FIGS. 3 and 4, the main body section 411 includes an opening section 4111, in which the wavelength conversion element 43 is fit, in substantially the center. The opening section 4111 is formed in a substantially rectangular shape when viewed from the incident side of the excitation light EL. The opening section 4111 pierces through the main body section 411 (the substrate 41) along the incident direction (the +Z direction) of the excitation light EL. A reflection layer 42 is formed on an inner end face of the opening section 4111. The wavelength conversion element 43 is disposed in the opening section 4111 to be connected to the inner end face via the reflection layer 42. That is, a side surface 433 crossing a crossing direction (e.g., the +X direction and the +Y direction) crossing the +Z direction in the wavelength conversion element 43 is connected to the inner end face of the opening section 4111.

The projecting section 412 is a part including the emission-side projecting section according to the invention. The projecting section 412 projects from the main body section 411 to the +Z-direction side (the opposite side of the incident side of the excitation light EL). The projecting section 412 includes an inclined surface 4121 inclined in a direction further away from the wavelength conversion element 43 toward the +Z direction from an end portion on the +Z-direction side on the inner end face of the opening section 4111. In other words, the projecting section 412 includes the inclined surface 4121 inclined in a direction further away from the inner end face of the opening section 4111 toward the +Z direction. Since the projecting section 412 is provided in the substrate 41, a dimension along the +Z direction of the substrate 41 is larger than a dimension along the +Z direction of the wavelength conversion element 43.

As explained above, the emitted light LT is diffused and emitted from the emission surface 432 of the wavelength conversion element 43. Therefore, when an inclination angle of the inclined surface 4121 with respect to the +Z direction is small, a phenomenon called optical vignetting easily occurs in which a part of the emitted light LT is made incident on the projecting section 412 (the inclined surface 4121) and light on the outer circumference side in the emitted light LT is blocked.

On the other hand, the inclined surface 4121 (an emission-side inclined surface) is formed as a reflection surface on which the reflection layer 42 is formed. Therefore, since the part of the emitted light LT made incident on the projecting section 412 is reflected by the inclined surface 4121, an emitted light amount from the wavelength conversion device 4 is suppressed from being reduced by the optical vignetting. Substantially the entire emitted light LT is made incident on the collimate lens 313. If the inclination angle of the inclined surface 4121 with respect to the +Z direction is an angle that does not cause the optical vignetting, the reflection layer 42 maybe absent on the inclined surface 4121.

Note that the reflection layer 42 is formed on the inner end face of the opening section 4111 and the inclined surface 4121 by, for example, vapor deposition. The heat of the wavelength conversion element 43 is conducted to the substrate 41 in the inner surfaces via the reflection layer 42.

Thickness Dimension of the Substrate with Respect to the Wavelength Conversion Element

In the wavelength conversion device 4, a dimension L2 of the substrate 41 along the +Z direction (a sum of a dimension L21 of the main body section 411 and a dimension L22 of the projecting section 412 along the +Z direction) is set to approximately 1.9 times as large as a dimension L1 of the wavelength conversion element 43 along the +Z direction.

Specifically, in the wavelength conversion device 4, the dimension L1 of the wavelength conversion element 43 along the +Z direction is set to approximately 1 mm. On the other hand, the dimension L2 of the substrate 41 along the +Z direction is set to approximately 1.9 mm. Specifically, the dimension L21 of the main body section 411 along the +Z direction is set to approximately 1 mm same as the dimension L1 of the wavelength conversion element 43 along the +Z direction. The dimension L22 of the projecting section 412 along the +Z direction is set to approximately 0.9 mm smaller than the dimension L1 of the wavelength conversion element 43 along the +Z direction.

### Effects of the Embodiment

The projector 1 according to this embodiment explained above achieves effects explained below.

The dimension L2 along the +Z direction of the substrate 41 that supports the wavelength conversion element (the dimension L2 along the incident direction of the excitation light EL) is larger than the dimension L1 along the +Z direction of the wavelength conversion element 43. Consequently, it is possible to set an area of a cross section orthogonal to the crossing direction (e.g., the +X direction and the +Y direction) crossing the +Z direction in the substrate 41 larger than an area of a cross section orthogonal to the crossing direction in the wavelength conversion element 43 (a contact area of contact with the inner end face of the opening section 4111 in the wavelength conversion element 43). Therefore, since it is possible to set the area of the cross section of the substrate 41 large compared with when the dimension L2 is equal to or smaller than the dimension L1, it is possible to expand a sectional area of a conduction path of heat conducted in a direction away from the wavelength conversion element 43 on the inside of the substrate 41. Consequently, it is possible to reduce the thermal resistance of the substrate 41. It is possible to efficiently conduct heat, which is transferred from the wavelength conversion element 43 to the substrate 41, to a part away from the wavelength conversion element 43 in the substrate 41 without allowing the heat to be filled in the inside of the substrate 41. It is possible to effectively radiate the heat in the substrate 41, the area of the cross section of which is larger than the area of the cross section of the wavelength conversion element 43. Therefore, it is possible to effectively cool the wavelength conversion element 43. It is possible to suppress wavelength conversion efficiency from being deteriorated in the wavelength conversion element 43.

The wavelength conversion element 43 is fit in the opening section 4111 of the substrate 41. Therefore, the wavelength conversion element 43 is connected to the inner end face of the opening section 4111 in a state in which the side surface 433 crossing in the crossing direction crossing the +Z direction is surrounded by the inner end face of the opening section 4111. Accordingly, for example, compared with when only a part of the side surface 433 is connected to the substrate 41, it is possible to expand the contact area of the wavelength conversion element 43 and the substrate 41. Therefore, it is possible to efficiently transfer heat generated in the wavelength conversion element 43 to the substrate 41.

The substrate 41 includes the projecting section 412 located in the +Z direction (the opposite side of the incident side of the excitation light EL) with respect to the wavelength conversion element 43. Accordingly, it is possible to surely set the area of the cross section of the substrate 41 larger than the area of the cross section of the wavelength conversion element 43. Consequently, it is possible to efficiently conduct the heat which is transferred from the wavelength conversion element 43, in a direction away from the wavelength conversion element 43 in the substrate 41. Therefore, it is possible to more effectively cool the wavelength conversion element 43.

The projecting section 412 includes the inclined surface 4121 further away from the wavelength conversion element 43 toward the +Z direction. Accordingly, compared with when the inclined surface 4121 is absent (e.g., when the inner end face of the opening section 4111 extends along the +Z direction), it is possible to suppress the emitted light LT emitted from the wavelength conversion element 43 from being blocked by the projecting section 412.

The inclined surface 4121, on which the reflection layer 42 is formed, functions as a reflection surface. Accordingly, even when a part of the emitted light LT diffused and emitted from the wavelength conversion element 43 is made incident on the projecting section 412, it is possible to reflect the part of the emitted light LT with the inclined surface 4121. Therefore, since it is possible to easily emit the part of the emitted light LT to the outside of the wavelength conversion device 4, it is possible to easily make substantially the entire emitted light LT incident on the collimate lens 313 located downstream on the optical path.

The wavelength conversion element 43 is formed by an inorganic material. Accordingly, compared with when the wavelength conversion element 43 is formed by an organic material, it is possible to suppress deterioration of the wavelength conversion element 43.

Therefore, it is possible to improve the reliability of the wavelength conversion device 4.

The lighting device 31 including the wavelength conversion device 4 can effectively cool the wavelength conversion element 43. Therefore, it is possible to suppress deterioration in wavelength conversion efficiency in the wavelength conversion element 43. Consequently, it is possible to stably convert the wavelength of the excitation light EL made incident on the wavelength conversion device 4 (the wavelength conversion element 43). The lighting device 31 can stably emit illumination light. Therefore, it is possible to improve the reliability and the stability of the lighting device 31.

The excitation light EL made incident on the wavelength conversion element 43 is blue light. The converted light of the excitation light EL converted and emitted by the wavelength conversion element 43 is fluorescent light including red light and green light. Accordingly, as explained above, by adjusting the type and the concentration of the phosphor such that a part of the excitation light EL and the fluorescent light are emitted from the wavelength conversion element 43, it is possible to configure the lighting device 31 such that the emitted light LT, which is white light, is emitted. Consequently, it is unnecessary to separately provide a component that divides the excitation light EL emitted from the solid-state light source 311 and combines the excitation light EL with the fluorescent light emitted from the wavelength conversion element 43 and a light source that emits the blue light combined with the fluorescent light. Therefore, it is possible to simplify the configuration of the lighting device 31.

The projector 1 includes the lighting device 31 including the wavelength conversion device 4. Therefore, it is possible to modulate the illumination light stably emitted from the lighting device 31 and form and project an image. Therefore, it is possible to improve the reliability and the stability of the projector 1.

### Modifications of the Embodiment

The invention is not limited to the embodiment. Modifications, improvements, and the like within a range in which the object of the invention can be achieved are included in the invention.

In the embodiment, the substrate 41 of the wavelength conversion device 4 includes the main body section 411 and the projecting section 412. The projecting section 412 is located on the emission side of the emitted light LT with respect to the wavelength conversion element 43. However, the invention is not limited to this. The shape of the substrate 41 may be other shapes. For example, wavelength conversion devices 4A to 4D explained below may be adopted in the lighting device 31 instead of the wavelength conversion device 4.

Note that, in the following explanation, portions same as or substantially the same as the portions explained above are denoted by the same reference numerals and signs and explanation of the portions is omitted.

### First Modification

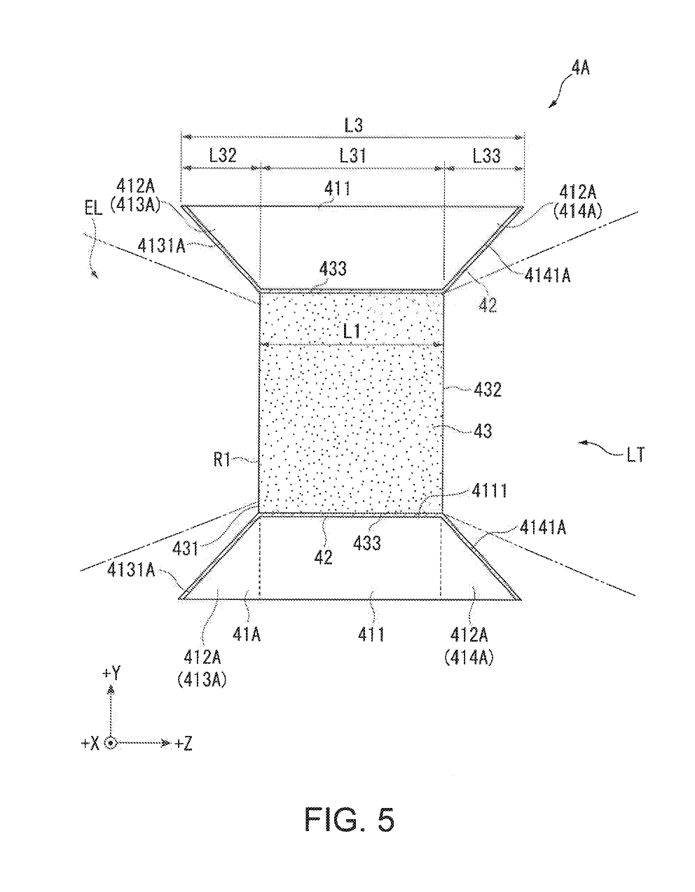

FIG. 5 is a sectional view showing the wavelength conversion device 4A, which is a first modification of the wavelength conversion device 4.

The wavelength conversion device 4A includes components and functions same as the components and the functions of the wavelength conversion device 4 except that the wavelength conversion device 4A includes a substrate 41A instead of the substrate 41 as shown in FIG. 5.

The substrate 41A is a member including the main body section 411 and a projecting section 412A, which are integrally formed. The projecting section 412A includes an incident-side projecting section 413A and an emission-side projecting section 414A.

The incident-side projecting section 413A is a part projecting to the −Z direction (the incident side of the excitation light EL) in the substrate 41A. The incident-side projecting section 413A includes an incident-side inclined surface 4131A, which is an inclined surface inclined in a direction further away from the wavelength conversion element 43 fit in the opening section 4111 toward the −Z direction from an end portion on the −Z-direction side on the inner end face of the opening section 4111. The incident-side inclined surface 4131A is a reflection surface on which the reflection layer 42 is formed.

The emission-side projecting section 414A is a part projecting to the +Z-direction side (the opposite side of the incident side of the excitation light EL; the emission side of the emitted light LT) in the substrate 41A. The emission-side projecting section 414A includes an emission-side inclined surface 4141A, which is an inclined surface inclined in a direction further away from the wavelength conversion element 43 toward the +Z direction from an end portion on the +Z-direction side on the inner end face of the opening section 4111. The emission-side inclined surface 4141A is a reflection surface on which the reflection layer 42 is formed.

Inclination angles with respect to the +Z direction of the incident-side inclined surface 4131A and the emission-side inclined surface 4141A are the same. The inclination angles are larger than an inclination angle with respect to the +Z direction of the inclined surface 4121.

The inclination angle of the incident-side inclined surface 4131A is set to an angle at which the excitation light EL made incident on the wavelength conversion element 43 is not made incident on the incident-side projecting section 413A (the incident-side inclined surface 4131A). Similarly, the inclination angle of the emission-side inclined surface 4141A is set to an angle at which occurrence of the optical vignetting explained above is suppressed and the emitted light LT diffused and emitted from the emission surface 432 is not made incident on the emission-side projecting section 414A (the emission-side inclined surface 4141A). Therefore, the reflection layer 42 does not have to be formed on the inclined surfaces 4131A and 4141A.

In the wavelength conversion device 4A, a dimension L3 of the substrate 41A along the +Z direction (a sum of a dimension L31 of the main body section 411, a dimension L32 of the incident-side projecting section 413A, and a dimension L33 of the emission-side projecting section 414A along the +Z direction) is set to approximately 1.7 times as large as the dimension L1 of the wavelength conversion element 43 along the +Z direction.

Specifically, in the wavelength conversion device 4A, the dimension L3 of the substrate 41A along the +Z direction is set to approximately 1.7 mm. The dimension L31 of the main body section 411 along the +Z direction is set to approximately 1 mm same as the dimension L1 of the wavelength conversion element 43 along the +Z direction. On the other hand, the dimension L32 of the incident-side projecting section 413A and the dimension L33 of the emission-side projecting section 414A along the +Z direction are respectively set to approximately 0.35 mm.

In this way, the dimension L3 of the substrate 41A along the +Z direction is larger than the dimension L1 of the wavelength conversion element 43 along the +Z direction. Therefore, as in the substrate 41, compared with when the dimension L3 is equal to or smaller than the dimension L1, it is possible to expand a sectional area of a conduction path of heat conducted in a direction away from the wavelength conversion element 43 on the inside of the substrate 41A. Consequently, it is possible to reduce the thermal resistance of the substrate 41A. It is possible to efficiently conduct heat, which is transferred from the wavelength conversion element 43 to the substrate 41A, to a part away from the wavelength conversion element 43 in the substrate 41 without allowing the heat to be filled in the inside of the substrate 41A. Therefore, it is possible to effectively cool the wavelength conversion element 43. It is possible to suppress deterioration in wavelength conversion efficiency in the wavelength conversion element 43.

### Effects of the First Modification

The wavelength conversion device 4A explained above is adopted in the lighting device 31 instead of the wavelength conversion device 4. Consequently, it is possible to achieve effects explained below besides achieving effects same as the effects of the lighting device 31 including the wavelength conversion device 4.

The substrate 41A includes the incident-side projecting section 413A and the emission-side projecting section 414A. Accordingly, compared with when the projecting sections 413A and 414A are absent, it is possible to expand an area of the conduction path. It is possible to efficiently conduct heat, which is transferred from the wavelength conversion element 43, to a part away from the wavelength conversion element 43 without allowing the heat to be filled in the inside of the substrate 41A. Therefore, it is possible to effectively cool the wavelength conversion element 43. It is possible to suppress wavelength conversion efficiency from being deteriorated in the wavelength conversion element 43.

The incident-side projecting section 413A includes the incident-side inclined surface 4131A. The emission-side projecting section 414A includes the emission-side inclined surface 4141A. The reflection layer 42 is formed on the inclined surfaces 4131A and 4141A. Accordingly, even when the excitation light EL is made incident on the incident-side inclined surface 4131A, it is possible to reflect the excitation light EL on the incident-side inclined surface 4131A. Even when the emitted light LT is made incident on the emission-side inclined surface 4141A, it is possible to reflect the emitted light LT on the emission-side inclined surface 4141A. Therefore, it is possible to suppress a decrease in a light amount of the excitation light EL made incident on the wavelength conversion element 43 and a decrease in a light amount of the emitted light LT emitted from the wavelength conversion element 43. It is possible to suppress a decrease in a light amount of the illumination light emitted from the wavelength conversion device 4A and the lighting device 31.

### Second Modification

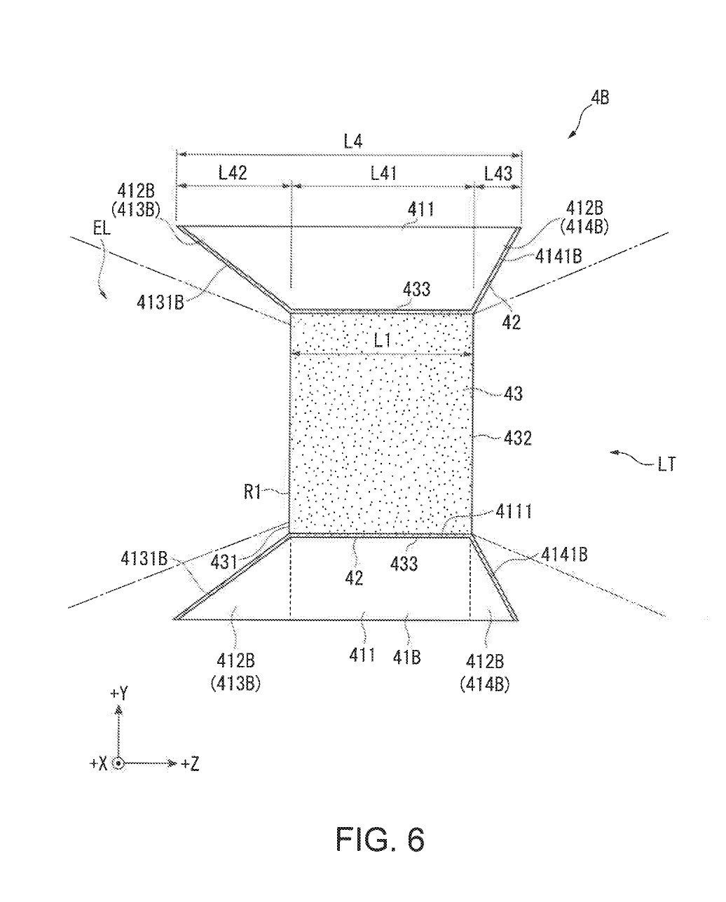

FIG. 6 is a sectional view showing a wavelength conversion device 4B, which is a second modification of the wavelength conversion device 4.

The wavelength conversion device 4B includes components and functions same as the components and the functions of the wavelength conversion device 4A except that the wavelength conversion device 4B includes a substrate 41B instead of the substrate 41A as shown in FIG. 6.

The substrate 41B is a member including the main body section 411 and a projecting section 412B, which are integrally formed. The projecting section 412B includes an incident-side projecting section 413B and an emission-side projecting section 414B.

An incident-side inclined surface 4131B included in the incident-side projecting section 413B is inclined with respect to the +Z direction like the incident-side inclined surface 4131A. An emission-side inclined surface 4141B included in the emission-side projecting section 414B is inclined with respect to the +Z direction like the emission-side inclined surface 4141A. However, inclination angles with respect to the +Z direction of the inclined surfaces 4131B and 4141B are different from the inclination angles of the inclined surfaces 4131A and 4141A. Note that the inclined surfaces 4131B and 4141B are also reflection surfaces on which the reflection layer 42 is formed.

Specifically, the inclination angle of the incident-side inclined surface 4131B with respect to the +Z direction is set to an angle smaller than the inclination angle of the incident-side inclined surface 4131A with respect to the +Z direction. The inclination angle of the incident-side inclined surface 4131B is also set to an angle at which the excitation light EL made incident on the wavelength conversion element 43 is not made incident on the incident-side inclined surface 4131B. Therefore, the reflection layer 42 does not have to be formed on the incident-side inclined surface 4131B.

On the other hand, the emission-side inclined surface 4141B is sharply inclined with respect to the inner end face of the opening section 4111. The inclination angle of the emission-side inclined surface 4141B with respect to the +Z direction is set to an angle larger than the inclination angles of the inclined surface 4121 and the emission-side inclined surface 4141A with respect to the +Z direction. The inclination angle of the emission-side inclined surface 4141B is also set to an angle at which the emitted light LT is not made incident on the emission-side inclined surface 4141B. Therefore, the reflection layer 42 does not have to be formed on the emission-side inclined surface 4141B.

In the wavelength conversion device 4B explained above, a dimension L4 of the substrate 41B along the +Z direction (a sum of a dimension L41 of the main body section 411, a dimension L42 of the incident-side projecting section 413B, and a dimension L43 of the emission-side projecting section 414B along the +Z direction) is set to approximately 1.7 times as large as the dimension L1 of the wavelength conversion element 43 along the +Z direction.

Specifically, in the wavelength conversion device 4B, the dimension L4 of the substrate 41B along the +Z direction is set to approximately 1.7 mm. The dimension L41 of the main body section 411 along the +Z direction is set to approximately 1 mm same as the dimension L1 of the wavelength conversion element 43 along the +Z direction. On the other hand, the dimension L43 of the incident-side projecting section 413B along the +Z direction is set to approximately 0.5 mm. The dimension L42 of the emission-side projecting section 414B is set to approximately 0.20 mm.

### Effects of the Second Modification

The wavelength conversion device 4B explained above is adopted in the lighting device 31 instead of the wavelength conversion device 4A. Consequently, it is possible to achieve effects explained below besides achieving effects same as the effects of the lighting device 31 including the wavelength conversion device 4A.

The inclination angle of the emission-side inclined surface 4141B with respect to the +Z direction is larger than the inclination angle of the emission-side inclined surface 4141A with respect to the +Z direction. Accordingly, it is possible to further suppress the emitted light LT diffused and emitted from the emission surface 432 of the wavelength conversion element 43 from being made incident on the emission-side inclined surface 4141B. Therefore, it is possible to more effectively suppress the emitted light LT from being blocked by the substrate 41B (the emission-side projecting section 414B).

### Third Modification

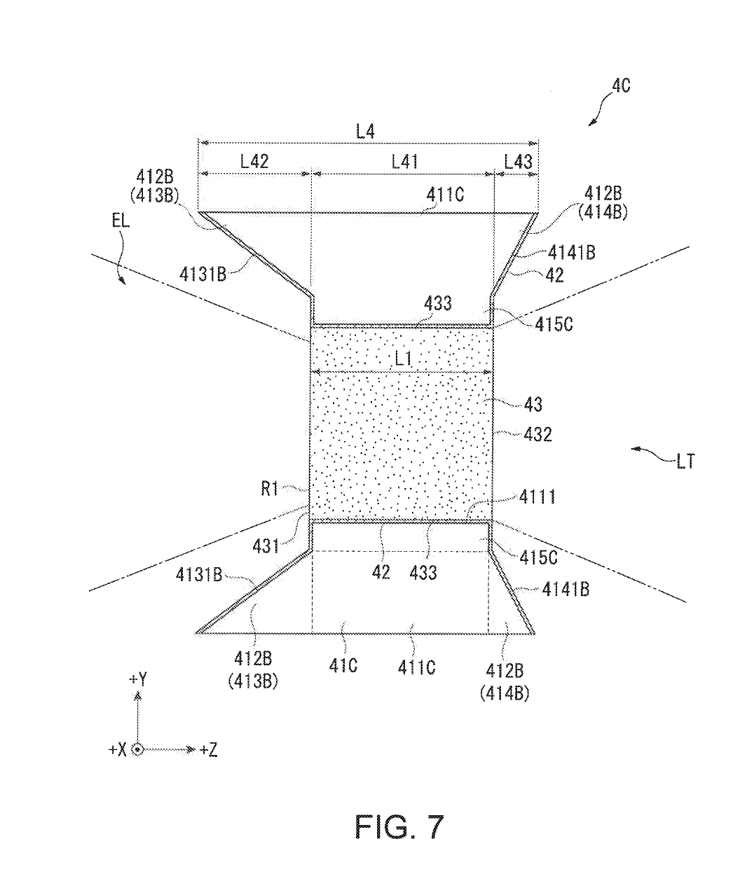

FIG. 7 is a sectional view showing a wavelength conversion device 4C, which is a third modification of the wavelength conversion device 4.

The wavelength conversion device 4C includes components and functions same as the components and the functions of the wavelength conversion device 4B except that the wavelength conversion device 4C includes a substrate 41C instead of the substrate 41B as shown in FIG. 6.

The substrate 41C includes a main body section 411C and the projecting section 412B including the incident-side projecting section 413B and the emission-side projecting section 414B. The main body section 411C and the projecting section 412B are integrally formed.

The main body section 411C includes an extending section 415C that extends to the wavelength conversion element 43 side. The opening section 4111 is formed in the extending section 415C. In other words, the inclined surfaces 4131B and 4141B of the incident-side projecting section 413B and the emission-side projecting section 414B are inclined as explained above from positions a predetermined dimension away from the inner end face of the opening section 4111 in a direction crossing the +Z direction by the length of the extended section 415C.

Note that the reflection layer 42 is formed in a part of the substrate 41C, which includes the extending section 415C, opposed to the wavelength conversion element 43. The wavelength conversion element 43 is connected to the inner end face of the opening section 4111 via the reflection layer 42.

### Effects of the Third Modification

The wavelength conversion device 4C explained above is adopted in the lighting device 31 instead of the wavelength conversion device 4B. Consequently, it is possible to achieve effects explained below besides achieving effects same as the effects of the lighting device 31 including the wavelength conversion device 4B.

Since the main body section 411C of the substrate 41C includes the extending section 415C, compared with the substrate 41B, it is possible to easily separate the projecting sections 413B and 414B from the wavelength conversion element 43. Consequently, it is possible to further suppress the excitation light EL made incident from the wavelength conversion element 43 from being made incident on the incident-side projecting section 413B. Further, it is possible to further suppress the emitted light LT emitted from the wavelength conversion element 43 from being made incident on the emission-side projecting section 414B. Therefore, it is possible to suppress the excitation light EL and the emitted light LT from being blocked by the substrate 41C. It is possible to suppress a decrease in a light amount of light emitted from the wavelength conversion device 4C and the lighting device 31.

### Fourth Modification

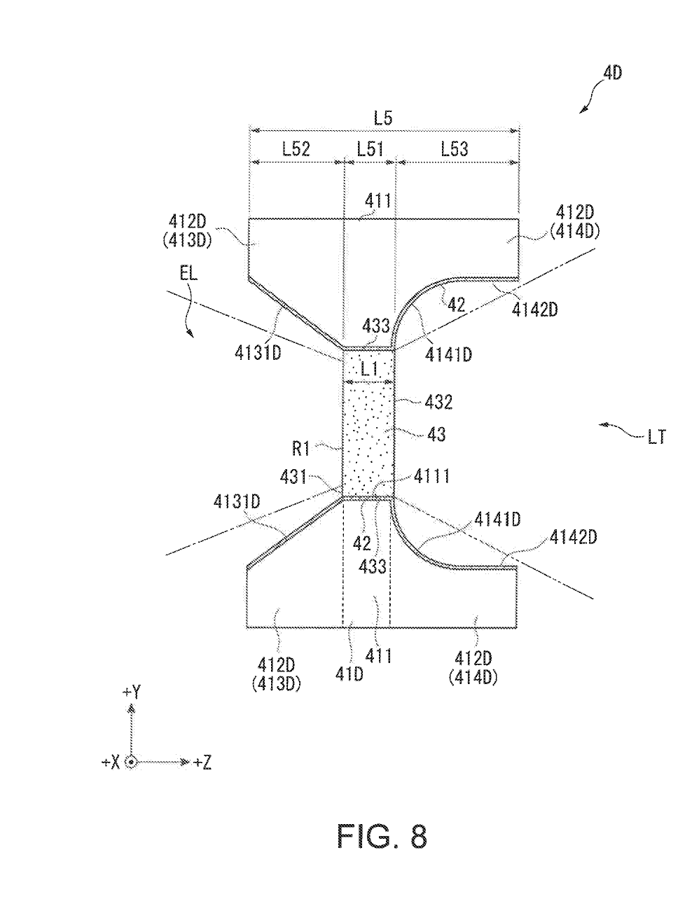

FIG. 8 is a sectional view showing a wavelength conversion device 4D, which is a fourth modification of the wavelength conversion device 4.

The wavelength conversion device 4D includes components and functions same as the components and the functions of the wavelength conversion device 4 except that the wavelength conversion device 4D includes a substrate 41D instead of the substrate 41 as shown in FIG. 8.

The substrate 41D is a member including the main body section 411 and a projecting section 412D, which are integrally formed. The projecting section 412D includes an incident-side projecting section 413D and an emission-side projecting section 414D.

The incident-side projecting section 413D is a part projecting to the −Z-direction side (the incident side of the excitation light EL) in the substrate 41D. The incident-side projecting section 413D includes an incident-side inclined surface 4131D, which is an inclined surface inclined in a direction further away from the wavelength conversion element toward the −Z direction from the end portion on the −Z-direction side on the inner end face of the opening section 4111. An inclination angle with respect to the +Z direction of the incident-side inclined surface 4131D is set the same as the incident-side inclined surface 4131B. The inclination angle is set such that the excitation light EL is not made incident on the incident-side projecting section 413D. As in the above explanation, the reflection layer 42 is formed on the incident-side inclined surface 4131D.

The emission-side projecting section 414D is a part projecting to the +Z-direction side (the opposite side of the incident side of the excitation light EL) in the substrate 41D. The emission-side projecting section 414D includes an emission-side inclined surface 4141D inclined in the direction further away from the wavelength conversion element 43 toward the +Z direction from the end portion on the +Z-direction side on the inner end face of the opening section 4111 and a plane 4142D located on the +Z-direction side with respect to the emission-side inclined surface 4141D.

The emission-side inclined surface 4141D is curved in a direction further away from the wavelength conversion element 43 toward the +Z direction. For example, a sectional shape along a YZ plane of the emission-side inclined surface 4141D is formed in a concave shape.

The plane 4142D extends substantially in parallel to the inner end face of the opening section 4111 from the end portion on the +Z-direction side in the emission-side inclined surface 4141D.

The reflection layer 42 is also formed on the emission-side inclined surface 4141D and the plane 4142D.

In the wavelength conversion device 4D, a dimension L5 of the substrate 41D along the +Z direction (a sum of a dimension L51 of the main body section 411, a dimension L52 of the incident-side projecting section 413D, and a dimension L53 of the emission-side projecting section 414D along the +Z direction) is set to approximately 5.5 times as large as the dimension L1 of the wavelength conversion element 43 along the +Z direction.

Specifically, in the wavelength conversion device 4D, the dimension L5 of the substrate 41D along the +Z direction is set to approximately 7.8 mm. The dimension L51 of the main body section 411 along the +Z direction is set to approximately 1 mm same as the dimension L1 of the wavelength conversion element 43 along the +Z direction. On the other hand, the dimension L52 of the incident-side projecting section 413D along the +Z direction is set to approximately 2.7 mm. The dimension L53 of the emission-side projecting section 414D is set to approximately 4.1 mm.

### Effects of the Fourth Modification

The wavelength conversion device 4D explained above is adopted in the lighting device 31 instead of the wavelength conversion devices 4A to 4C. Consequently, it is possible to achieve effects explained below besides achieving effects same as the effects of the lighting device 31 including the wavelength conversion devices 4A to 4C.

Since the emission-side inclined surface 4141D is curved as explained above, it is possible to easily separate the emission-side inclined surface 4141D (the emission-side projecting section 414D) from the wavelength conversion element 43. Consequently, it is possible to suppress the emitted light LT emitted from the wavelength conversion element 43 from being made incident on the emission-side projecting section 414D. It is possible to suppress the emission-side projecting section 414D (the substrate 41D) from blocking the emitted light LT. Therefore, it is possible to suppress a decrease in alight amount of light emitted from the wavelength conversion device 4D.

Since the emission-side inclined surface 4141D is curved, compared with when the inclined surface 4141D is formed in a flat shape, it is possible to expand an area of the emission-side inclined surface 4141D, that is, a heat radiation area of heat transferred to the substrate 41D. Therefore, it is possible to improve cooling efficiency of the wavelength conversion element 43.

### Other Modifications

In the embodiment and the modifications explained above, the substrates 41 and 41A to 41D include the opening section 4111 that pierces through the substrate 41 along the +Z direction and in which the wavelength conversion element 43 is fit. However, the invention is not limited to this. For example, the substrates 41 and 41A to 41D may be configured by a plurality of members that are in contact with the side surface 433 of the wavelength conversion element 43 and support (hold) the wavelength conversion element 43 in the direction crossing the +Z direction. The members configuring the substrates 41 and 41A to 41D may be one member. That is, the substrates 41 and 41A to 41D only have to be in contact with at least a part of the side surface 433. The opening section 4111 may be absent. The shape of the opening section 4111 is not limited to the rectangular shape and may be, for example, a circular shape.

In the embodiment and the modifications, the substrates 41 and 41A to 41D include the projecting section 412 and the emission-side projecting sections 414A, 414B, and 414D projecting in the +Z-direction side with respect to the wavelength conversion element 43. However, the invention is not limited to this. The substrates 41 and 41A to 41D may include only the incident-side projecting section projecting to the incident side of the excitation light with respect to the wavelength conversion element.

The incident-side inclined surface of the incident-side projecting section may be curved like the emission-side inclined surface 4141D. Even when an inclined surface is curved, only a part of the inclined surface may be curved.

In the embodiment and the modifications, the wavelength conversion devices 4 and 4A to 4D are the wavelength conversion device of the transmission type that emits the emitted light LT along the incident direction of the excitation light EL. That is, the wavelength conversion devices 4 and 4A to 4D include the wavelength conversion element 43 in which the incident surface 431 of the excitation light EL and the emission surface 432 of the emitted light LT are on the opposite sides each other. However, the invention is not limited to this. The invention may be applied to a wavelength conversion device of a reflection type that emits the emitted light LT in a direction opposite to the incident direction of the excitation light EL.

In the embodiment and the modifications, the projecting sections 412, 412A, 412B, and 412D include the inclined surface inclined (curved) in the direction further away from the wavelength conversion element 43 toward the +Z direction or the −Z direction. However, the invention is not limited to this. The projecting sections 412, 412A, 412B, and 412D do not have to include the inclined surface. For example, the substrates 41 and 41A to 41D may have a configuration in which the inner end face of the opening section 4111 extends to the +Z-direction side or the −Z-direction side with respect to the wavelength conversion element 43 fit in the opening section 4111. For example, the substrate 41 and 41A to 41D may be inclined in a direction further approaching the wavelength conversion element 43 toward the +Z direction or the −Z direction as long as the substrates 41 and 41A to 41D do not block the excitation light EL made incident on the wavelength conversion element 43 and the emitted light LT emitted from the wavelength conversion element 43.

In the embodiment and the modifications, the wavelength conversion element 43 is configured by the inorganic material (the ceramic phosphor). However, the invention is not limited to this. For example, the wavelength conversion element 43 may be formed by an organic material such as resin (a phosphor or the like including a resin binder).

In the embodiment and the modifications, the reflection layer 42 is formed on the inner end face of the opening section 4111, the inclined surface 4121, the incident-side inclined surfaces 4131A, 4131B, and 4131D, the emission-side inclined surfaces 4141A, 4141B, and 4141D, and the plane 4142D. However, the invention is not limited to this. For example, as explained above, the reflection layer 42 may be absent.

For example, if the reflection layer 42 is absent on the inner end face of the opening section 4111, the side surface 433 of the wavelength conversion element 43 and the inner end face of the opening section 4111 are in direct contact with each other. Therefore, it is possible to more efficiently transfer the heat of the wavelength conversion element 43 to the inner end face of the opening section 4111 and the substrate 41 functioning as the heat radiation member.

In the embodiment and the modifications, the lighting device 31 includes, as the light source that emits the excitation light made incident on the wavelength conversion devices 4 and 4A to 4D, the solid-state light source 311 that emits the excitation light having the peak wavelength in the wavelength region of approximately 455 nm. The wavelength conversion device 4 emits, as the converted light, the fluorescent light including the green light and the red light. However, the invention is not limited to this. The wavelengths of the excitation light and the converted light are not limited to the above as long as the wavelength of the light made incident on the wavelength conversion element 43 and the wavelength of the light generated in the wavelength conversion element 43 are different.

The wavelength conversion element 43 converts a part of the incident excitation light EL into the fluorescent light, which is the converted light, and emits the emitted light LT including another part of the excitation light and the converted light.

However, the invention is not limited to this. The wavelength conversion element 43 may be configured to convert the wavelength of the entire incident excitation light into the wavelength of the converted light.

In the embodiment and the modifications, the dimensions L2 to L5 of the substrates 41 and 41A to 41D in the +Z direction are set to approximately 1.9 times, approximately 1.7 times, and approximately 5.5 times as large as the dimension L1 of the wavelength conversion element 43 in the +Z direction. However, the invention is not limited to this. Magnifications of the dimensions L2 to L5 with respect to the dimension L1 can be changed as appropriate as long as the magnifications exceed 1. The dimensions of the main body sections 411 and 411C, the projecting section 412, the incident-side projecting sections 413A, 413B, and 413D, and the emission-side projecting sections 414A, 414B, and 414D in the +Z direction can also be changed as appropriate.

In the embodiment and the modifications, the projector 1 includes the three light modulation devices 34 (34R, 34G, and 34B). However, the invention is not limited to this. The invention can also be applied to, for example, a projector including two or less or four or more light modulation devices.

The light modulation device 34 includes the liquid crystal panel, the light incident surface and the light emission surface of which are different. However, the invention is not limited to this. A light modulation device including a liquid crystal panel of a reflection type, a light incident surface and a light emission surface of which are the same may be adopted. A light modulation device other than liquid crystal such as a device including a micro mirror, for example, a device including a DMD (Digital Micromirror Device) may be adopted as long as the light modulation device is a light modulation device capable of modulating an incident light beam and forming an image corresponding to image information.

In the embodiment and the modifications, the wavelength conversion devices 4 and 4A to 4D are explained as the wavelength conversion device used in the projector 1. However, the invention is not limited to this.

For example, the wavelength conversion devices 4 to 4A to 4D may be configured to be used in an independently usable lighting device rather than the lighting device 31 of the projector 1. In this case, the lighting device only has to include the solid-state light source 311 and the wavelength conversion device 4. For example, any one of the condensing optical device 312, the collimate lens 313, the first lens array 314, the second lens array 315, and the polarization conversion element 316 may be absent.

What is claimed is:

1. A wavelength conversion device comprising:
a wavelength conversion element configured to convert at least a part of incident excitation light into converted light having a wavelength different from a wavelength of the excitation light and emit the converted light; and
a substrate connected to the wavelength conversion element in a crossing direction crossing an incident direction of the excitation light on the wavelength conversion element and configured to radiate heat transferred from the wavelength conversion element, wherein
a dimension of the substrate along the incident direction is larger than a dimension of the wavelength conversion element along the incident direction.

2. The wavelength conversion device according to claim 1, wherein the substrate includes an opening section penetrating through the substrate along the incident direction, the wavelength conversion element being fit in the opening section.

3. The wavelength conversion device according to claim 1, wherein
the substrate includes a projecting section located on at least either one of an incident side of the excitation light and an opposite side of the incident side of the excitation light with respect to the wavelength conversion element, and
the projecting section includes an inclined surface further away from the wavelength conversion element toward a disposition side of the projecting section with respect to the wavelength conversion element.

4. The wavelength conversion device according to claim 3, wherein
the projecting section includes an incident-side projecting section located on an incident side of the excitation light with respect to the wavelength conversion element, and
an incident-side inclined surface, which is the inclined surface in the incident-side projecting section, reflects the incident light.

5. The wavelength conversion device according to claim 3, wherein
the wavelength conversion element includes:
an incident surface on which the excitation light is made incident; and
an emission surface located on an opposite side of the incident surface, the converted light being emitted from the emission surface,
the projecting section includes an emission-side projecting section located on an opposite side of the incident side of the excitation light with respect to the wavelength conversion element, the opposite side being an emission side of the converted light from the emission surface, and
an emission-side inclined surface, which is the inclined surface in the emission-side projecting section, reflects the incident light.

6. The wavelength conversion device according to claim 5, wherein at least apart of the emission-side inclined surface is curved in a direction further away from the wavelength conversion element toward the emission side of the converted light.

7. The wavelength conversion device according to claim 1, wherein the wavelength conversion element is formed by an inorganic material.

8. A lighting device comprising:
the wavelength conversion device according to claim 1; and
a light source configured to emit the excitation light.

9. A lighting device comprising:
the wavelength conversion device according to claim 2; and
a light source configured to emit the excitation light.

10. A lighting device comprising:
the wavelength conversion device according to claim 3; and
a light source configured to emit the excitation light.

11. A lighting device comprising:
the wavelength conversion device according to claim 4; and
a light source configured to emit the excitation light.

12. A lighting device comprising:
the wavelength conversion device according to claim 5; and
a light source configured to emit the excitation light.

13. A lighting device comprising:
the wavelength conversion device according to claim 6; and
a light source configured to emit the excitation light.

14. A lighting device comprising:
the wavelength conversion device according to claim 7; and
a light source configured to emit the excitation light.

15. The lighting device according to claim 8, wherein
the excitation light is blue light, and
the converted light includes red light and green light.

16. A projector comprising:
the lighting device according to claim 8;
a light modulation device configured to modulate light emitted from the lighting device; and
a projection optical device configured to project the light modulated by the light modulation device.

17. A projector comprising:
the lighting device according to claim 15;
a light modulation device configured to modulate light emitted from the lighting device; and
a projection optical device configured to project the light modulated by the light modulation device.
